(19) United States
(12) Patent Application Publication
(10) Pub. No.: US 2026/0134415 A1
(43) Pub. Date: May 14, 2026

(54) SYSTEM AND METHOD TO FACILITATE FINANCIAL SERVICES ACCESSIBLE FROM A VEHICLE

(71) Applicant: JPMorgan Chase Bank, N.A., New York, NY (US)

(72) Inventor: Somnath Ghosh, Hockessin, DE (US)

(73) Assignee: JPMorgan Chase Bank, N.A., New York, NY (US)

(21) Appl. No.: 19/387,822

(22) Filed: Nov. 13, 2025

Related U.S. Application Data
(60) Provisional application No. 63/719,793, filed on Nov. 13, 2024.

(51) Int. Cl. G06Q 20/32; B60K 35/10; B60K 35/22; G06Q 20/40

(52) U.S. Cl. CPC G06Q 20/322; B60K 35/10; B60K 35/22; G06Q 20/40145; G06Q 20/405; B60K 2360/741

(57) ABSTRACT

Aspects of the subject disclosure may include, for example receiving (e.g., at a vehicle communication system of a vehicle) a command (e.g., a voice command) from a user representing a request for a financial service associated with a financial services platform; providing (e.g., via an API) an authentication request to an authentication platform (which may be integrated with the financial services platform or may be a separate platform); responsive to a successful authentication of the user by the authentication platform, determining whether the financial service is authorized for the user during transit; in response to a determination that the financial service is not authorized for the user during transit, presenting a notification (e.g., a visual message shown at a vehicle display and/or an audio message played over the vehicle audio system) to stop the vehicle to continue with the financial service. Other embodiments are disclosed.

### CROSS-REFERENCE TO RELATED APPLICATION

This application claims the benefit of and priority to U.S. Provisional Ser. No. 63/719,793, filed Nov. 13, 2024. The contents of the foregoing are hereby incorporated by reference into this application as if set forth herein in full.

### FIELD OF THE DISCLOSURE

The subject disclosure relates to a system and method to facilitate financial services accessible from a vehicle.

### BACKGROUND

The automotive industry has seen a growing interest in incorporating advanced functionalities that enhance the driving experience and improve safety. This development aims to address the increasing concern over cognitive distractions caused by mobile phone usage while driving. Existing mobile applications, while convenient, pose significant risks when used by drivers. The National Highway Traffic Safety Administration (NHTSA) has reported numerous accidents attributed to distractions from mobile devices.

### SUMMARY OF THE DISCLOSURE

One or more aspects of the subject disclosure include a method for managing financial services. The method may include receiving, by a processing system including a processor, a voice command from a user representing a request for a financial service associated with a financial services platform, where the processing system is part of a vehicle communication system of a vehicle. The method may include providing, by the processing system via an Application Programming Interface (API), an authentication request to an authentication platform. The method may include responsive to a successful authentication of the user by the authentication platform, determining, by the processing system, whether the financial service is authorized for the user during transit. The method may include, in response to a determination that the financial service is not authorized for the user during transit, presenting, by the processing system, a notification to stop the vehicle to continue with the financial service.

One or more aspects of the subject disclosure include a server, comprising: a processing system including a processor; and a memory that stores executable instructions that, when executed by the processing system, facilitate performance of operations. The operations may include receiving, via an API, a registration request for a user associated with a financial services platform that provides financial services via a vehicle communication system of a vehicle. The operations may include transmitting a third-party request to a third-party database to obtain user data associated with the user and with the vehicle. The operations may include completing the registration based in part on the user data.

One or more aspects of the subject disclosure include a non-transitory machine-readable medium, comprising executable instructions operating in association with a software development kit that, when executed by a processing system including a processor of a vehicle communication system of a vehicle, facilitate performance of operations. The operations may include receiving a voice command from a user representing a request for a financial service associated with a financial services platform. The operations may include providing, via an API, an authentication request to an authentication platform. The operations may include responsive to a successful authentication of the user by the authentication platform, determining whether the financial service is authorized for the user during transit. The operations may include, in response to a determination that the financial service is not authorized for the user during transit, presenting a notification to stop the vehicle to continue with the financial service.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system that facilitates financial services in accordance with various aspects described herein.

FIG. 2 is a block diagram illustrating an exemplary, non-limiting embodiment of a vehicle with a vehicle communication system of the system of FIG. 1 in accordance with various aspects described herein.

FIG. 3 is a block diagram illustrating an exemplary, non-limiting embodiment of a display of the vehicle communication system of FIGS. 1 and 2 in accordance with various aspects described herein.

FIG. 4 depicts an illustrative embodiment of a method that includes providing financial services in accordance with various aspects described herein.

FIG. 5 is a block diagram of an example, non-limiting embodiment of a computing environment in accordance with various aspects described herein.

### DETAILED DESCRIPTION

The subject disclosure describes, among other things, illustrative embodiments for providing access to financial services or transactions in an environment where a user may lack privacy and/or lack focus, such as interacting with a vehicle communication system. The financial services or transactions may be of various types associated with various institutions or entities including banks, brokerage firms, credit card companies, pay services, and so forth. In one or more embodiments, the system and methodology may distinguish transactions between those that may be performed via voice commands and those that require user interaction with a vehicle display. These distinctions may be pre-determined or may be dynamically adjusted. In one or more embodiments, the system and methodology may present a notice that the vehicle needs to be stopped or placed in park transmission mode for certain financial transactions to avoid any distraction to a driver while operating the vehicle. In one or more embodiments, the system and methodology may be provided through software, hardware, and a combination thereof, which may include one or more entities providing, supplying and/or managing the software and/or hardware (or portions and components thereof), including software and/or hardware of a financial institution, of a vehicle manufacturer and/or of a third party. In one embodiment, the financial institution (or a third-party provider) may provide software (e.g., a Software Development Kit) that works with hardware of a vehicle in sending and receiving information that is processed by the infrastructure of the financial institution. In one or more embodiments, voice profile and/or visual image data can be stored in a storage platform(s) which may be compliant with a retention policy of the entity, which may also be particular to the data or type of data being stored rather than being stored in an SDK platform (such as of the vehicle). Other embodiments are described in the subject disclosure.

In one or more embodiments, the system and methodology may integrate financial services into vehicles (e.g., cars) through voice commands, allowing users to perform certain banking or other financial operations from the vehicle, which may include during driving. This system and methodology reduce cognitive distractions by enabling certain voice-activated transactions, such as checking balances, without the need for a mobile device. In one or more embodiments, the system and methodology may apply multi-factor authentication using voice, image and/or biometric analysis and profiles, and may utilize vehicle sensors or components (e.g., integrated cameras, fingerprint analyzer, microphone) for recognition. In one or more embodiments, the system and methodology may provide a Software Development Kit (SDK) for integration with various car manufacturer software or components, creating a new device footprint for automobiles distinct from mobile or web applications.

In one or more embodiments, the system and methodology enable users to perform financial transactions using voice commands while driving, which may include integration with the vehicle's existing infrastructure and/or functionality to execute commands such as checking balances, contacting customer service, transferring money, and so forth. In one or more embodiments, the system and methodology enable authenticating users in a vehicle using voice, image and/or biometric profiles, including facial recognition through integrated cameras. This may include enhancing security by implementing multi-factor authentication, such as sending a One-Time Password (OTP) to the vehicle's display/screen. In one or more embodiments, baseline and current biometric information (e.g., a user image) may be stored at various devices, including in the infrastructure of the financial institution, in the vehicle, in a device associated with the user, and/or so forth. Policies for information retention may vary and/or may be authorized by the user, such as requiring destruction of an image captured in conjunction with a rental car. In other embodiments, retention of information may be subject to other factors, including retaining the information for a particular period of time in the event of an investigation or audit associated with use of the financial services.

In one or more embodiments, the system and methodology provide a profile service (e.g., shared between user devices and the financial services platform) ensuring only authorized users may perform transactions within the vehicle. For instance, this service may convert voice commands into API requests to interact with existing banking infrastructure. In one or more embodiments, the system and methodology may provide one or more SDKs designed for integration with various car manufacturer components and/or functionality so as to facilitate the customization needed for different vehicle systems to support financial transactions. As described herein, the SDKs may be created by various entities including the financial institution(s), car manufacturer(s) and/or third-party App developers.

In one or more embodiments, the system and methodology may provide temporary access management for non-owned vehicles. For instance, the system and methodology may interact with third-party systems (e.g., Department of Motor Vehicles (DMVs), rental car agencies, etc.) to manage temporary access for non-owned vehicles. This third-party record access may also be utilized for facilitating authentication/validation/confirmation (e.g., at different stages of the financial transaction including at initiation or completion), such as when a user is onboarding a newly purchased vehicle and ownership or registration is verified via the local DMV.

One or more of the exemplary embodiments describe registration requests being made or otherwise transmitted. These registration requests may be of various types including a one-time registration request such as when a user is first provisioning his or her owned or registered vehicle (or someone else's vehicle that is authorized to be used) for utilizing the processes described herein. In one or more embodiments, a registration request may be for multiple vehicles including providing the request through a first vehicle or a website portal, and then applying at least some of the provisioned information for use with the system and process as applied to other vehicles. This may include providing additional information for other vehicles, such as an initial registration request being made via a first vehicle and then providing additional information when utilizing the system and methodology the next time at a different vehicle(s). In other embodiments, the registration requests may be repeatable or temporary requests, such as for temporarily utilizing the service on a particular vehicle, such as a rental car, a friend's vehicle, a public transportation vehicle, an airplane, etc. As described herein, these registration requests may be used with methodology that allows provisioned information to be removed such as after a time period in a rental vehicle.

In one or more embodiments, the system and methodology enable safety measures to detect suspicious activities or threats. For example, AI-driven safety and threat detection may be employed where an AI-based system assesses situations to detect suspicious activities or threats within the vehicle. In one embodiment, this system may alert authorities if necessary, enhancing the security of financial transactions. In one or more embodiments, the system and methodology may provide for in-vehicle payment for services. For example, the system and methodology may enable payments for services such as gas without leaving the car or payment at a drive-thru window without providing a debit card. This system may expand the vehicle's capabilities to include real-time financial transactions.

In one or more embodiments, the system and methodology: receives voice commands from a user (e.g., a driver or a passenger) within a vehicle to initiate a financial transaction; authenticates a user using multi-factor authentication where the authentication includes at least one of voice recognition, image recognition or biometric verification through integrated sensors of the vehicle; converts the voice commands into API requests to interact with a banking infrastructure; executes the financial transaction based on the authenticated voice commands; and provides confirmation of the transaction to the user via the vehicle's interface. In one or more embodiments, particular transactions may be selectively enabled depending on the motion or other status of the vehicle (e.g., parked, running, etc.).

One or more of the exemplary embodiments may be applied to any vehicle (e.g., a car, a bus, a plane, a train, a boat, etc.). For example, the system and methodology may be applied to screens provided in a headrest of a plane seat where a user desires to conduct financial transactions while on the plane. Continuing with this example, the system and methodology may utilize airline records such as the identity of the passenger, a photograph of the passenger (which may be captured during check-in), and the assigned seat to facilitate the financial transactions and the authentication/validation/confirmation for those transactions.

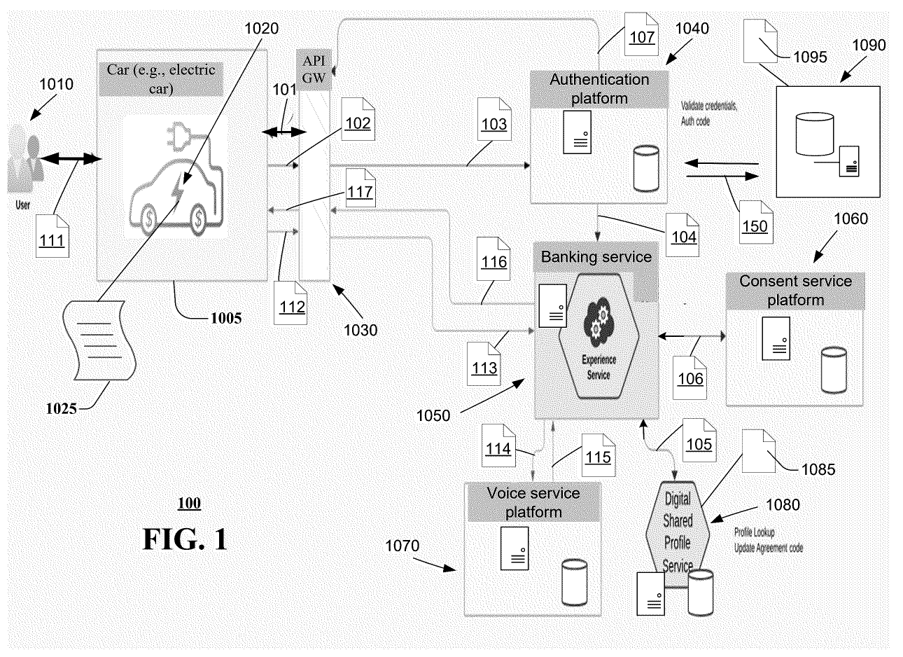

FIG. 1 is a block diagram illustrating an exemplary, non-limiting embodiment of a system 100 in accordance with various aspects described herein. System 100 may provide user 1010 (a driver or a passenger) with financial services (e.g., banking services) via a Vehicle Communication System (VCS) 1020, as well as other computing functionality and communication services, including voice, video, data, entertainment, and/or messaging services. It should be understood that system 100 may include various components and functionality for providing financial and communication services, and may be coupled to one or more wireless networks for facilitating access to the communication services, such as a wireless connection to a service provider network (not shown) via various types of radio access technologies, including 5G or NG communications. In one or more embodiments, other communication techniques may be implemented including use of vehicle WiFi, access point devices, WiFi hotspots, personal hot spots (e.g., on a user's mobile phone) and so forth to facilitate the communications for the methodology described herein. These other types of communications may be utilized to provide a more secure connection for some or all of the messaging, such as through a user's mobile phone hot spot. In one or more embodiments, the methodology may include generating a request to a user (e.g., via the vehicle communication system) to utilize the user's mobile phone hot spot which may include establishing a Virtual Private Network (VPN) connection for secure transactions for the user and financial institution. In one or more embodiments, the methodology may include providing more secure communications, such as establishing a VPN for communications between the user and the financial institution.

System 100 includes components and functionality for facilitating financial services being provided from within a vehicle 1005 (e.g., a car) through use of the vehicle communication system 1020. However, it should be understood that the systems and methodology described herein are applicable to other types of vehicles or other types of environments (e.g., where a user desires to engage in financial services but may lack privacy).

System 100 integrates financial services into vehicles, such as a car 1005. The system 100 may include a user 1010, the VCS 1020, an API Gateway (GW) 1030, a Digital Authentication Service (DAS) 1040, a financial services platform 1050 (e.g., banking services), a Consent Service Datastore or platform (CSD) 1060, a Voice service/Command Platform (VCP) 1070, a User Information Datastore or platform (UID) 1080, and a third-party records database 1090. These components and functionality are shown separately in FIG. 1, however, it should be understood that two or more of the components or functionality may be combined, such as the CSD 1060 and the UID 1080 being integrated with each other.

Various data flows, communications or messaging may be performed within the system 100 such as the API GW 1030 providing API access 101, registration information or request 102 communicated between the VCS 1020 and the API GW, API request 103 communicated between the API GW and the DAS 1040, Authentication and Registration Message (AARM) 104 communicated between the DAS and the financial services platform 1050, User Data Message (UDM) 105 communicated between the financial services platform and the UID 1080, consent/acknowledgement messaging 106 communicated between the financial services platform and the CSD 1060, and the Registration and Authentication Response (RAAR) 107 communicated between the DAS and the API GW. Additionally, system 100 shows user request 111 communicated between the user 1010 and the VCS 1020, UE request 112 communicated between the VCS and the API GW 1030, API service request 113 communicated between the API GW and the financial services platform 1050, voice command 114 communicated between the financial services platform 1050 and the VSP 1070, service command 115 communicated between the VSP and the financial services platform, service response 116 communicated between the financial services platform and the API GW, API service response 117 communicated between the API GW and the VCS, and Third-Party Registration Data (TPRD) 150 communicated between the DAS 1040 and the third-party records database 1090. System 100 may also utilize an SDK 1025, which facilitates the methodology described herein being utilized with the VCS 1020. In one or more embodiments, the SDK may be created, modified or managed by various entities including a financial institution, a vehicle manufacturer, a third-party App developer, etc. For instance, a third-party app developer may create an SDK that is usable for different financial institutions and/or different vehicle manufacturers.

In one or more embodiments, the user 1010 interacts with the system 100 by initiating the user request 111, such as a voice command to access the financial services platform 1050 or to obtain a particular financial transaction. This request 111 may be provided to the platform 1050 via the API GW 1030 through requests 112, 113 and may be processed by the VCP 1070 when received as voice command 114.

The VCS 1020 may manage API access 101 and registration 102, facilitating communication with or via the API GW 1030. For example, the API GW 1030 may process API requests 103 and route them to the appropriate components, functions or services. The DAS 1040 may handle AARM 104, ensuring secure user authentication through communications with the financial services platform 1050. The DAS 1040 may interact with the third-party records database (e.g., a DMV, car rental agency, etc.) to validate credentials and authentication codes, including ownership or registration information associated with the vehicle. The DAS 1040 may send the RAAR 107 back to the VCS 1020 as part of the authentication process. In one or more embodiments, location information for the vehicle may be accessed to facilitate the authentication process. Other authentication or verification techniques may also be employed including multi-factor authentication (e.g., through a user's mobile phone), location confirmation (e.g., comparing to a known or predicted location of the user such as based on location information for the user's phone or other device that the user is believed to be in possession of). Obtaining location data for the user may be done according to user authorization and any required regulations. In one or more embodiments, location information may be utilized for limiting or managing use of the methodology described herein, such as preventing use of the methodology when the vehicle is located at the user's premises since the user may instead utilize a home computer and this may prevent an unauthorized user from trying to access the methodology while the vehicle is parked at the user's premises. In other embodiments, the methodology may include designating particular areas where it may be used such as a particular highway or a particular distance away from the user's premises. In other embodiments, the methodology may include designating particular areas where particular types of authentications (including location-based authentications) may or may not be utilized or required.

In one or more embodiments, a user may be provided with a link (or other tool for access) for providing information that facilitates the various processes described herein (e.g., user authentication), which may include a driver's license, a rental agreement, a vehicle registration, a vehicle title, an auto insurance card, etc. The link may be of various types including enabling uploading of images of the information.

In one embodiment, once onboarding has occurred and an initial login is authenticated, the financial services platform 1050 may process API service requests 113, which are generated by the API GW 1030 from the user requests 111 (for financial transactions) and may convert them into service commands 115 utilizing the VCP 1070 from voice commands 114. The financial services platform 1050 may interact with the CSD 1060 to obtain consent and acknowledgement for utilizing the services. System 100 further includes other functionality such as validating partner applications, customer eligibility, and/or account eligibility.

The financial services platform 1050 may send service responses 116 to the VCS 1020 via the API GW 1030 for presentation to the user 1010. The CSD 1060 may communicate and store consent records 106 and may interact with or otherwise communicate with other devices (e.g., transmitting data 150), such as third-party database 1090 that manage or store third-party registration/validation/authentication data 1095. The CSD 1060 may ensure that the user consents to and acknowledges authorized transactions being processed within the system 100.

The VCP 1070 may process voice commands 114 from the user 1010, converting them into actionable requests. The financial services platform 1050 may interact with the UID 1080 to perform profile lookups, ensuring that user preferences and permissions are respected, and baseline data for voice, image and/or biometric analysis may be performed.

The UID 1080 stores user profiles 1085 and maintains up-to-date user information including baseline user data. This ensures that the system 100 may provide personalized and secure financial services to the user 1010. The SDK 1025 facilitates integration with various car manufacturers, allowing the system 100 to be customized for different vehicle systems. This enables the seamless execution of financial transactions across a wide range of vehicles.

In one or more embodiments, the SDK 1025 serves as a set of tools and resources that developers use to create applications for specific platforms. In the context of integrating a banking service into vehicle 1005, the SDK 1025 facilitates the development and customization of software that allows the systems of the vehicle 1005 to interact with the banking service. The SDK 1025 provides the necessary libraries, documentation, and sample code to enable developers to build applications that may communicate with the existing infrastructure of the vehicle 1005. This includes integrating voice command capabilities, user authentication, and secure data transmission between the vehicle and the banking service. By using the SDK 1025, developers may ensure that the banking service is compatible with various vehicle systems, allowing seamless execution of financial transactions. The SDK 1025 allows customization to accommodate different car manufacturers'requirements, ensuring that the banking service may be integrated into a wide range of vehicles including electric vehicles. Overall, the SDK 1025 acts as a bridge between the VCS 1020 and the banking service platform 1050, enabling the implementation of voice-activated financial transactions and other related functionalities within the vehicle environment.

In one or more embodiments, the SDK 1025 may be located in whole or in part within the VCS 1020 of the vehicle 1005. It facilitates integration with various car manufacturers, allowing customization for different vehicle systems to support financial transactions.

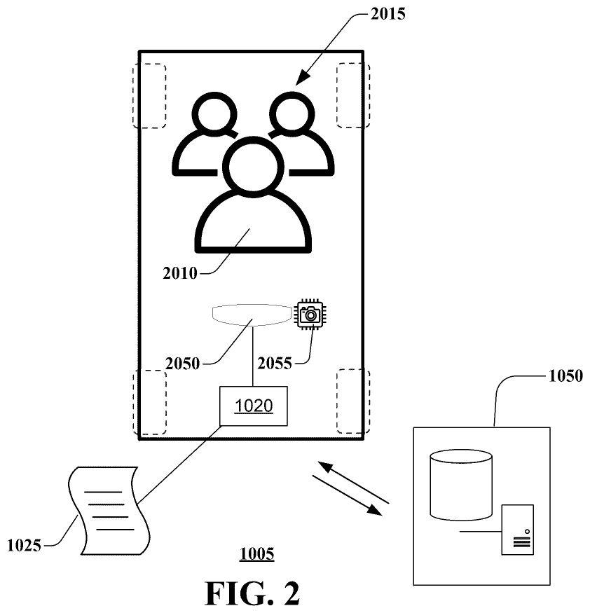

FIG. 2 is a block diagram illustrating an exemplary, non-limiting embodiment of vehicle 1005 of system 100 of FIG. 1. In this example, a user 2010 is shown with other persons 2015 inside the vehicle 1005. The vehicle 1005 includes the vehicle communication system 1020 which has a video display 2050 and a camera 2055 (e.g., an integrated camera in the display). As explained herein, the SDK 1025 may facilitate the VCS 1020 providing various financial transaction services through communications with the financial services platform 1050.

As described herein, the VCS 1020 may serve as a central communication hub within the vehicle 1005. The SDK 1025 allows leveraging computing functionality of the VCS 1020 for providing a driver or passengers (user 2010) with financial transaction services. The VCS 1020 may manage interactions between the user 2010 and the systems of vehicle 1005, facilitating the execution of voice-activated financial transactions (e.g., while the vehicle is in motion) and facilitating the execution of financial transactions that utilize interaction with the display 2050 (e.g., while the vehicle is stopped or in park transmission mode).

The SDK 1025 enables integration with various car manufacturer components and functionality, and allows customization of the system for different vehicle systems. This may ensure compatibility and seamless execution of financial transactions across a wide range of vehicles, which may be utilizing different operating systems and/or having different capabilities, such as image capture vs. audio capture.

The display 2050 may provide visual feedback to the user 2010 regarding transaction status and other relevant information. The display 2050 enhances user interaction by confirming actions and displaying necessary prompts. The camera 2055 may be utilized for image capturing, such as facial recognition to be utilized during authentication/validation/confirmation associated with the financial transaction(s). The camera 2055 enhances security by ensuring that only authenticated users may access financial services within the vehicle 1005. In one or more embodiments, information appearing on the display 2050 may be presented or managed in various ways, including automatic removal after a particular time period (e.g., deleting a transaction complete notice after 10 seconds) such as where the vehicle is in motion. Other techniques for information management may also be utilized including techniques intended to avoid distraction of a driver such as preventing certain transactions from occurring when the vehicle is travelling over a certain speed. In other embodiments, acknowledgement notices may be utilized when a vehicle is stopped but may be removed or not presented when the vehicle is in motion (or in motion over a threshold speed). In other embodiments, detected or predicted circumstances associated with the vehicle may be utilized for managing presentation of information. For example, certain transactions may be prohibited and/or certain information presentations prohibited/delayed based on current surroundings or circumstances of the vehicle, such as detecting a vehicle is travelling at 60 mph with another vehicle within a threshold distance of the vehicle may preclude any use of the methodology and may include an audio warning to try again later. In other embodiments, the context of the information may be utilized for determining management of presentation of that same information, such as avoiding presenting a user with a new credit card bill over a threshold amount while the user is driving the vehicle over a threshold speed so that the user does not get distracted by the high bill. Other factors may be utilized for managing presentation of the information, and other techniques may be applied to analyzing the information, which may include AI/ML modeling.

In one or more embodiments, managing presentation of the information may be based on other events concurrently or predicted to be happening, such as delaying or preventing displaying account information when a steering wheel vibration is occurring that is representative of a lane violation or other undesired driving. In other embodiments, auto-corrections by the vehicle, such as auto-braking or auto-steering, may prevent or delay presentation of information at the display 2050. In other embodiments, timing of presentation may be adjusted according to detected circumstances, such as delaying presentation of information during a turn of over a threshold number of degrees and then presenting the information when the vehicle is travelling in a straight path. In one embodiment, asynchronous messaging may be implemented, such as detecting that a vehicle is travelling over a threshold speed and providing a message that the requested credit card statement will be made available at a later time, including when the vehicle is stopped or when the vehicle is travelling below a threshold speed.

The user 2010 may interact with the VCS 1020 by initiating voice commands for financial transactions. The input of the user 2010 may be processed by the VCS 1020 to perform the requested operations securely and efficiently utilizing various components and functionality described with respect to system 100 of FIG. 1.

Persons 2015 represent additional occupants in the vehicle who may provide privacy or other concerns for the user 2010. As an example, VCS 1020 may ensure that only authorized users (i.e., user 2010) may perform transactions, maintaining security and privacy. In one or more embodiments, the system and methodology may seek authorization from the user and/or other users in the vehicle, such as when utilizing imaging (e.g., for user authentication), the system may first ask for approval to capture the image from all of the occupants in the vehicle.

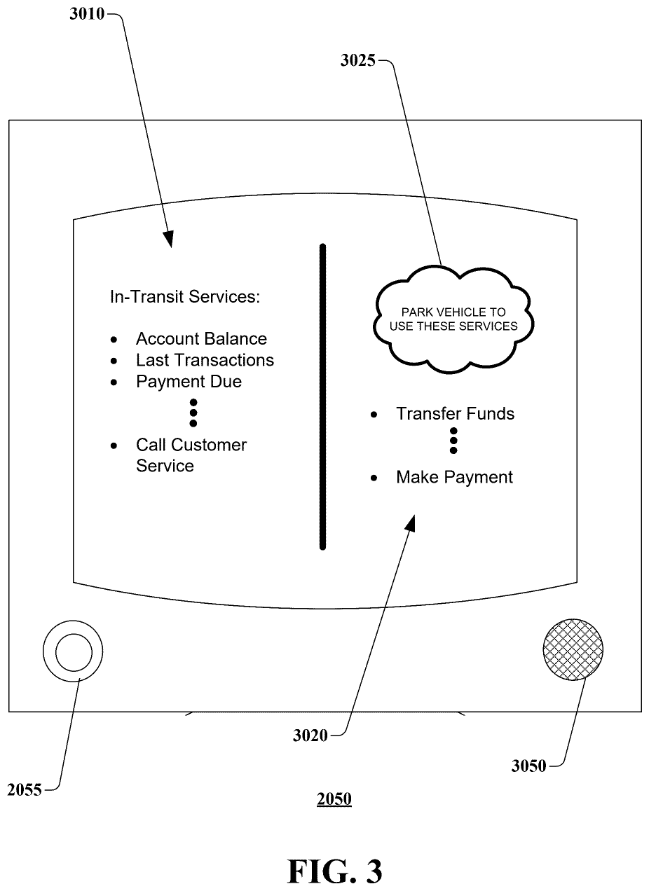

Referring additionally to FIG. 3, the display 2050 is shown with the camera 2055 and a microphone 3050 for receiving voice commands from the user (shown in FIG. 2). A group 3010 of financial services/transactions that are authorized during transit, and another group 3020 of financial services/transactions that are not authorized during transit are shown. The list of transactions in groups 3010, 3020 is meant to be an example and may change or otherwise be adjusted. Further, an in-transit vehicle may include the vehicle being in motion or the vehicle not being in a park transmission mode. In one or more embodiments, a request for a financial transaction from among the group 3020 may result in a warning or notification 3025 advising the user that the vehicle must be parked (or must be stopped). In one or more embodiments, transactions from among the group 3020 may require more focus of the user (e.g., interaction with the display 2050). As explained herein, the categorization of transactions into group 3010 or 3020 may be pre-determined and/or may be adjusted, including based on measuring a level of distraction for engaging in a particular transaction.

In one or more embodiments, the camera 2055 may capture an image of the user in the vehicle, where providing of an authentication request to an authentication platform includes providing the image.

In one or more embodiments, the camera 2055 may capture an image of an interior of the vehicle that includes the user. This allows the analysis of the image to determine that a person other than the user is in the interior of the vehicle. The analysis may be performed by the VCS 1020 (see FIGS. 1 and 2). In this example, a privacy rule may then be determined for the financial service/transaction based on the person (other than the user) being in the interior of the vehicle. The privacy rule that is implemented may include changing the authentication/validation/confirmation process so that private information is not exchanged, such as changing a requirement for a user password to be spoken as input by the user to utilizing an image capture of the user to avoid the user being required to state the password aloud. In one or more embodiments, the system and methodology may utilize fingerprint detection and matching for authentication, which may be captured at the display and/or may be captured on the steering wheel itself (e.g., a steering wheel that has a fingerprint detector integrated therein). In one embodiment, this type of authentication may be utilized in place of a spoken password, such as where a user seeks or needs privacy.

In one embodiment, a determination may be made that the vehicle has stopped; and then the financial service/transaction (e.g., from group 3020) may continue (e.g., which may be subject to a privacy rule). In one embodiment, a determination may be made that the vehicle has stopped; and then the financial service/transaction may continue by requiring the user to input information via a touch screen of the vehicle communication system. In one embodiment, additional verification or confirmation may be implemented after the vehicle is detected as stopped to confirm that the user should be utilizing the financial services, such as confirming that the user is capable of interacting with the display (e.g., is in good health as opposed to having been in an accident), which may be done in a number of different ways that may or may not include another authentication step.

In one embodiment, prior to receiving a voice command representing a request for a financial service/transaction, a registration request for the user may be provided that is associated with the financial services platform. In this example, a registration message (e.g., via an API) may be provided to a registration platform associated with the financial services platform.

In one embodiment, the registration message may cause a user profile associated with the user to be generated and stored at a database and/or to be accessed from the database. The user profile as described herein may include various user information associated with the financial services platform and may include user baseline data for performing a voice, image and/or biometric analysis for the user.

In one embodiment, the registration message may cause the registration platform to transmit a third-party request to a third-party database to obtain user data, such as to a DMV database so that ownership of the vehicle may be confirmed. In one or more embodiments, links or other input tools may be made available to a user for providing information that makes the methodology described herein available, such as for submitting an image of the rental agreement and the driver's license of the user. In other embodiments, provisional authentication may be provided (e.g., according to lesser authentication information) and then a follow-up of more secure information may be provided by the user within a required time period, such as in a situation where a rental car is being picked up in the evening when the DMV office is closed so a user may initially authenticate by submitting a driver's license and then at a later time the user may be authenticated according to the DMV records. In one or more embodiments, a provisional authentication may result in limited use of the methodology described herein, such as allowing for checking balances but not allowing for financial transactions until the full authentication is completed.

In one embodiment, the camera 2055 may capture an image of an interior of the vehicle that includes the user. An analysis may be performed (e.g., by the vehicle communication system 1020 of FIGS. 1 and 2) of the image to determine that a person other than the user is in the interior of the vehicle. In one embodiment, failing to identify the person in the interior of the vehicle may result in an identification failure, which may prevent the financial service from being completed based on the identification failure. In one embodiment, an alert may be transmitted (e.g., to a mobile phone of the user, to law enforcement, etc.) based on the preventing of the financial service from being completed.

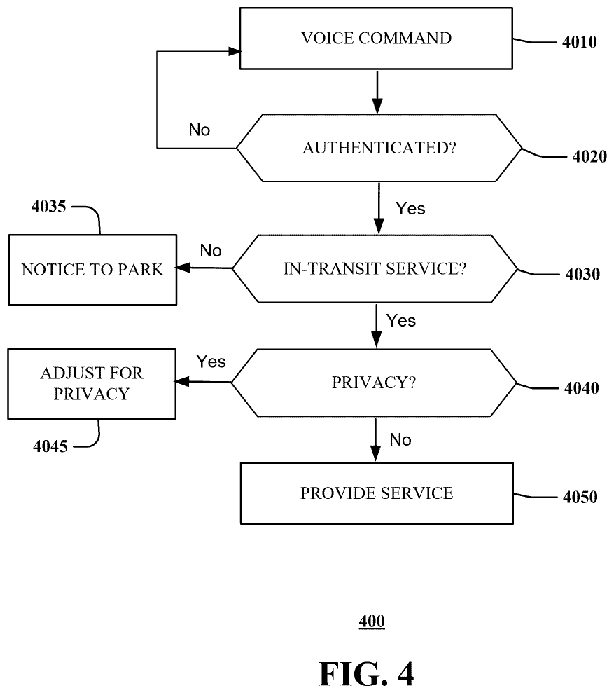

FIG. 4 shows a method 400 for providing financial services or transactions to a user which may be implemented by system 100 of FIG. 1. The functions described in method 400 may be performed in whole or in part by one or more of the devices and components of system 100, including vehicle communication system 1020, SDK 1025, financial services platform 1050, and so forth. The functions described in method 400 may also be facilitated by way of the communications, data transfer and messaging described with respect to system 100 of FIG. 1, including API access 101, registration 102 (which in some embodiments may include entering a driver's license such as for rental cars), API request 103, authentication and registration message 104, user data message 105, consent/acknowledgement messaging 106, registration and authentication response 107, user request 111, UE request 112, API service request 113, voice command 114, service command 115, service response 116, API service response 117, and third-party registration data communications 150. It should also be understood that one or more of the functions described with respect to method 400 may be performed by devices and/or communications that is not illustrated in FIG. 1.

As an example, method 400 enables executing voice-activated financial transactions within a vehicle. The method 400 may be implemented by a vehicle communication system to ensure secure and efficient processing of user requests. At 4010, a voice command may be received from the user, which may be a driver or a passenger. This voice command may initiate the process for performing a financial transaction or accessing a service within the vehicle. At 4020, the method 400 determines whether the user is authenticated. Authentication may be done in a number of different ways including password, account name, account information, voice recognition, image recognition, biometric verification and so forth. If the user is not authenticated, the process terminates or otherwise awaits another voice command. At 4030, the method 400 checks if the requested service is an in-transit service (e.g., a transaction of group 3010 of FIG. 3). If the service is not available while the vehicle is in motion or not available when the vehicle is outside of the park transmission mode, then the method 400 proceeds to 4035 where a notice to park the vehicle is presented (e.g., via the display and/or through an audio message). This ensures that certain services/transactions are only accessed when the vehicle is stationary, enhancing safety, particularly for services/transaction that may be distracting to a driver of the vehicle.

At 4040, the method 400 evaluates whether privacy adjustments are necessary. As an example, a privacy evaluation may include capturing an image of the interior of the vehicle to determine whether anyone else is present in addition to the user. In other embodiments, this may include identifying any other persons present and determining whether a privacy concern exists, such as identifying a child being present with the user which does not trigger a privacy concern as opposed to identifying a co-worker (or being unable to identify the other person) which leads to a privacy concern. If privacy concerns are identified, the method 400 proceeds to 4045 where the method 400 adjusts to ensure privacy. This may involve modifying the display or audio output to protect sensitive information. At 4050, the method 400 provides the requested service/transaction. As an example, this step may complete the transaction or service access, confirming the successful execution of the user's command.

In one or more embodiments, method 400 may apply AI modeling to manage the financial transactions that may be accessed and completed either in-transit or while stopped, including changing maximum transaction amounts, types of transactions, authentication techniques, and so forth. As an example, AI modeling may determine that voice recognition to verify a transfer of money is not as secure as image recognition because of a level of noise surrounding the vehicle.

While for purposes of simplicity of explanation, the respective processes are shown and described as a series of blocks in FIG. 4, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, method 400 may be utilized with various types of vehicles (e.g., cars, buses, planes, trains, boats, and so forth). For example, method 400 may be incorporated into a electric vehicle, a hybrid vehicle, a gas-powered vehicle or other-powered vehicle via an SDK that may be provided to the manufacturer of the vehicle to facilitate operations of method 400 in a communication system of the vehicle. In one or more embodiments, the system and methodology described herein may be provided by way of a console or other device that is available to any user. For example, this may include a screen at a bus station or a restaurant that allows for purchasing bus tickets/food and also allows for accessing the financial methodology described herein.

In one or more embodiments, method 400 may be implemented in a vehicle (particularly for a driver but also applicable to passengers) and may reduce cognitive distractions as compared to a user trying to conduct a financial transaction on his or her smart phone via a mobile app. For instance, types of transactions may be limited and may be categorized into transactions authorized during transit (e.g., while the vehicle is in motion or while the vehicle is not in park transmission mode) and transactions not authorized during transit (e.g., requires vehicle to be stopped or in park transmission mode). In one embodiment, transactions not authorized during transit may include transactions that utilize a non-voice input (e.g., a touch-screen display of the vehicle) to complete or facilitate the transaction, such as requiring a user to enter a pin code manually at the touch-screen or requiring the user to enter an address for a bill payment recipient.

In one or more embodiments, transactions authorized during transit may be initiated and/or completed through a voice command (which in some embodiments does not require any physical interaction with the touch-screen display), such as a balance inquiry, a payment deadline for a credit card, a last known transaction for a debit or credit card, and so forth.

In one or more embodiments, method 400 may be implemented in whole or in part by using an SDK(s) that is created for, or otherwise customized or tailored to, a vehicle industry, such as the automotive industry. As an example, a same or different SDKs may be made available to different vehicle manufacturers, which may be adjusted or configured according to capabilities of the vehicle, such as providing a first SDK to a first manufacturer that has a touch-screen display with image capturing capability (e.g., an integrated camera) and providing a second SDK to a second manufacturer that has a touch-screen display without image capturing capability. In other embodiments, different SDKs may be made available according to different operating systems associated with the vehicle communication systems including Android Automotive SDK, Apple CarPlay SDK, OpenXC, Aptiv SDX, Vehicle API, HERE SDK and other SDKs. For example, the SDK may be compatible with the particular vehicle communication system and/or other computing resources of the vehicle such as vehicle data, navigation and mapping, which may be useful information for other features of the method 400 as described herein (e.g., applying AI modeling to identify suspicious behavior associated with a financial transaction).

In one or more embodiments, method 400 may utilize a voice profile for the user which may be utilized to confirm or authenticate a particular transaction. As described herein, the type of authentication/confirmation may vary depending on the type of transaction or parameters associated with the transaction, such as allowing a payment from a debit card to be made to a gas pump via an authenticated voice command when the amount is under $30 but requiring a different authentication/confirmation for a transaction over $30. For instance, the different authentication (e.g., requiring a more difficult challenge), may require the user to speak a particular phrase, obtain an image of the user for a facial recognition authentication/confirmation, apply a multi-factor authentication such as requiring the user to input an answer to a security question at the touch-screen display device after the voice command for the payment over $30 has been authenticated/confirmed according to a voice profile analysis, and so forth.

In one or more embodiments, the type or selection of authentication/confirmation may be dynamic or may vary based on numerous factors, including user preferences, transaction types, transaction parameters, and/or application of AI modeling to provide an improved quality of experience for the user. For example, an AI model may dynamically increase a dollar amount threshold for requiring multi-factor authentication from $30 to $50 based on various analyzed factors including an increase in price of gas, a planned long-distance road-trip of the user, and a route through high-price gas areas.

In one or more embodiments, method 400 may store voice profiles, image profiles and/or user profiles (e.g., as a single profile and/or distinct profiles) which may be accessed and utilized to facilitate initiation and completion of the financial transaction(s). In one or more embodiments, method 400 may expand or increase its profiles as a user utilizes the method. For example, initially the voice profile may be based on certain phrases that the user is asked to enter as a baseline for later analysis (e.g., asking for a payment to be made, asking for a balance inquiry, or asking for a transfer of money). As the user utilizes the method 400 over time, the voice profile may be expanded (e.g., automatically and/or at the request of the user) to capture baselines for other phrases that are typically associated with these initial requests, such as amounts. For instance, the method 400 may establish a baseline for the user's request to transfer $50 to entity X from account Z, where the user makes this request frequently. Other profiles may be similarly expanded, such as capturing images of the user who might look different in the winter wearing a heavy coat and hat as compared to the summer wearing a t-shirt, glasses and/or baseball cap.

In one or more embodiments, method 400 may apply multi-factor authentication for a financial transaction by first receiving a request for the financial transaction (which may be authenticated/confirmed according to a voice profile) and then generating a text message on the display screen of the vehicle which the user would then need to read-aloud (or provide an answer to such as a security question) for an additional authentication/confirmation. As described herein, various forms of authentication/confirmation/validation for a financial transaction may be applied alone or in combination. In one or more embodiments, the authentication/confirmation/validation for the financial transaction may be based on a profile (or baseline data) that is stored at various locations, including one or more of a centralized repository for the financial transaction platform, an edge server to expedite transactions in a geographical area of the user, a storage device of the vehicle, a storage device of the user (e.g., in a home network), and so forth.

In one or more embodiments, method 400 may apply a constrained operation that limits the user to non-distracting transactions such as voice input commands and/or voice output responses (e.g., when the vehicle is in transit) and may apply a non-constrained operation where the user interacts with the touch-screen display for providing and/or receiving information associated with the financial transaction (e.g., when the vehicle is stopped). In other embodiments, the non-constrained operation of method 400 via the vehicle communication system may still be limited as compared to capabilities of a mobile phone app, utilizing an ATM machine and/or accessing the institution's website, such as preventing certain types of transactions or limiting an amount of certain transactions via the vehicle communication system due to security concerns.

In one or more embodiments, method 400 may operate, in part, similarly to a mobile phone app, an ATM machine and/or accessing the institution's website, such as an initial credential/authentication process which may require one or more of account name, password, voice recognition, image recognition, and so forth. For instance, this may be similar to what a user is accustomed to experiencing during a login procedure on the mobile phone app. After this procedure, the method 400 may obtain a consent and acknowledgement of the user as far as utilizing the financial services platform via the vehicle communication system. For instance, this consent may be on a number of different levels, including consent/acknowledgement based on requirements of the financial institution, requirements of government regulators (e.g., banking regulations), requirements of the vehicle industry, requirements of the vehicle manufacture, requirements of the NHTSA, and so forth, which may include safety rules for financial transactions during operation of a vehicle and which may include consenting to use particular features of the method 400. In other embodiments, the consent may include capturing, collecting and/or utilizing images and/or audio of the user (and driver, passengers and/or other persons in the vehicle) as described herein.

In one or more embodiments, method 400 may provide an initial onboarding that collects various information including baseline voice and/or image profiles, account information, user preferences, consent/acknowledgement agreements, and so forth. This onboarding may be done at a vehicle communication system and/or elsewhere including via the institution's website (in whole or in part). As an example, if a user has multiple cars in the ecosystem, the user may onboard from each car, from the institution's website, from one of the cars, and so forth. In one or more embodiments, subsequent onboarding for another vehicle may be a streamlined process that relies in part on data provided during the first onboarding but obtains additional information necessary for each of the vehicle communication systems of the other vehicles, such as obtaining a baseline image of the user for a subsequent onboarding where the subsequent vehicle has an integrated camera that allows for image authentication/validation/confirmation.

In one or more embodiments, method 400 may operate in conjunction with components and functionality of the vehicle, such as the vehicle communication system receiving a voice command to call customer service at the financial institution and interacting with a cellular service provided via the vehicle communication system for placing the phone call (which may utilize the user's mobile phone functionality that has been paired with the vehicle or may be a direct call in vehicles that have been equipped with such functionality). In one or more embodiments, access information, such as telephone numbers, may be provided via the SDK or software operating on the vehicle computing system or may be provided via contact information supplied by the user's mobile phone.

In one or more embodiments, method 400 may prevent a user from performing particular financial transactions or obtaining particular financial services, such as opening a new account which might require accessing the institution's website or visiting an office of the institution.

In one or more embodiments, method 400 may provide layers of security or validation during use of the financial services platform. For example, the initial login by the user may allow the user to access particular financial transactions via the vehicle communication system, however, initiation and completion of the financial transaction may require an additional authentication/confirmation/validation such as through a voice analysis, image analysis or some other process. For instance, a user may login to the financial platform via the vehicle communication system through password, account name, image recognition, etc. The user may request a money transfer of $100 to account X from account Y. Method 400 may then apply a subsequent authentication/confirmation/validation challenge by requiring the user to speak a particular phrase or by capturing an image of the user to which a voice/image analysis may be applied utilizing stored baselines for this information.

In one or more embodiments, method 400 may be utilized in conjunction with other service providers such as the travel industry (e.g., an airlines), e-commerce industry (e.g., an e-commerce website), gas stations, and so forth.

In one or more embodiments, method 400 may operate according to and be provisioned via a distinct device footprint for vehicles (e.g., automobiles) which is separate from web browsers, mobile apps, smartwatches, and so forth.

In one or more embodiments, method 400 may be configured for satisfying various legal risk compliance and controls associated with the financial industry and the automotive/travel industry.

In one or more embodiments, method 400 may be onboarded and operated in a vehicle that is not owned or registered to the user, including a friend's car, a rental car, a leased car, etc. In one or more embodiments, method 400 or information associated therewith such as account information may be removed (e.g., automatically) from vehicle communication systems. In one example, a change of information may occur due to a new vehicle registration or new vehicle ownership which may trigger automatic removal of the information. For instance, the removal may occur after a period of no use (e.g., one week), after expiration of a rental/lease agreement, change of ownership (e.g., which may be determined from third-party records such as accessing a Department of Motor Vehicles), and/or at the request of the user, such as when a car rental is being returned. In one embodiment, the removal may be a partial removal such as removing any information associated with the user but retaining system updates, and so forth. In other embodiments, a time period for removal of information may be based on allowing for audits or investigations and/or may be dynamically adjusted, such as retaining information for a longer period of time when a rental car has been in an accident.

In one or more embodiments, method 400 may apply restrictions to financial transaction based on detecting suspicious activity. For instance, a request for transferring money to an account that is not recognized or is being done while the vehicle is at an unfamiliar location may trigger a suspicious activity flag, which may result in further authentication/validation/confirmation being required to complete the transaction, may result in suspension of operation of any financial transactions via the vehicle communication system, and/or may result in an alert being provided to authorities/other persons regarding the suspicious activity

In one or more embodiments, method 400 may apply AI threat modeling to manage these procedures including analyzing other factors associated with the vehicle such as an image of the interior of the vehicle that is captured in response the suspicious activity flag, the location of the vehicle, identified (and/or non-identifiable) occupants of the vehicle, and so forth.

In one or more embodiments, method 400 may apply facial recognition to captured images to detect emotion such as distress of the user which may result in triggering of the suspicious activity flag.

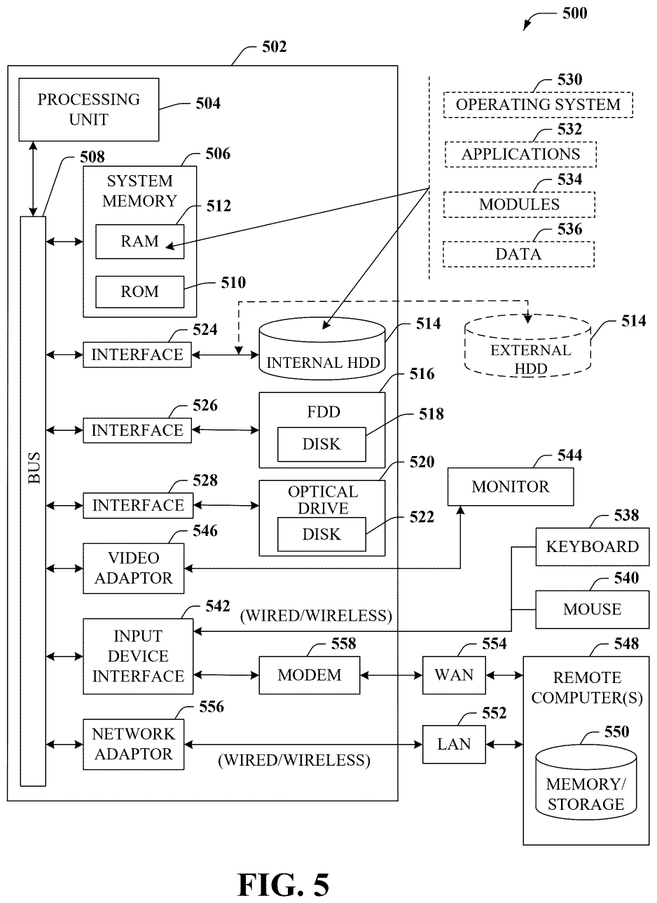

Turning now to FIG. 5, there is illustrated a block diagram of a computing environment in accordance with various aspects described herein. In order to provide additional context for various embodiments of the embodiments described herein, FIG. 5 and the following discussion are intended to provide a brief, general description of a suitable computing environment 500 in which the various embodiments of the subject disclosure may be implemented.

For example, computing environment 500 may facilitate in whole or in part

receiving (e.g., at a vehicle communication system of a vehicle) a command (e.g., a voice command) from a user representing a request for a financial service associated with a financial services platform; providing (e.g., via an API) an authentication request to an authentication platform (which may be integrated with the financial services platform or may be a separate platform); responsive to a successful authentication of the user by the authentication platform, determining whether the financial service is authorized for the user during transit; in response to a determination that the financial service is not authorized for the user during transit, presenting a notification (e.g., a visual message shown at a vehicle display and/or an audio message played over the vehicle audio system) to stop the vehicle to continue with the financial service. In one or more embodiments, the determining whether the financial service is authorized for the user during transit is based on a first group of financial services that are pre-determined to not be authorized during transit, and a second group of financial services are pre-determined to be authorized during transit. In one or more embodiments, an image of the user in the vehicle may be captured (e.g., by a camera of the vehicle communication system), where the providing of the authentication request to the authentication platform includes providing the image. One or more of the computing devices shown in FIGS. 1-3 or otherwise describe herein may include one or more components and/or functionality described with respect to FIG. 4.

Generally, program modules comprise routines, programs, components, data structures, etc., that perform particular tasks or implement particular abstract data types. Moreover, those skilled in the art will appreciate that the methods may be practiced with other computer system configurations, comprising single-processor or multiprocessor computer systems, minicomputers, mainframe computers, as well as personal computers, hand-held computing devices, microprocessor-based or programmable consumer electronics, and the like, each of which may be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein may be also practiced in distributed computing environments where certain tasks are performed by remote processing devices that are linked through a communications network. In a distributed computing environment, program modules may be located in both local and remote memory storage devices.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data.

Computer-readable storage media may comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media may be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 5, the example environment may comprise a computer 502, the computer 502 comprising a processing unit 504, a system memory 506 and a system bus 508. The system bus 508 couples system components including, but not limited to, the system memory 506 to the processing unit 504. The processing unit 504 may be any of various commercially available processors. Dual microprocessors and other multiprocessor architectures may also be employed as the processing unit 504.

The system bus 508 may be any of several types of bus structure that may further interconnect to a memory bus (with or without a memory controller), a peripheral bus, and a local bus using any of a variety of commercially available bus architectures. The system memory 506 comprises ROM 510 and RAM 512. A basic input/output system (BIOS) may be stored in a non-volatile memory such as ROM, erasable programmable read only memory (EPROM), EEPROM, which BIOS contains the basic routines that help to transfer information between elements within the computer 502, such as during startup. The RAM 512 may also comprise a high-speed RAM such as static RAM for caching data.

The computer 502 further comprises an internal hard disk drive (HDD) 514 (e.g., EIDE, SATA), which internal HDD 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high-capacity optical media such as the DVD). The HDD 514, magnetic FDD 516 and optical disk drive 520 may be connected to the system bus 508 by a hard disk drive interface 524, a magnetic disk drive interface 526 and an optical drive interface 528, respectively. The hard disk drive interface 524 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, may also be used in the example operating environment, and further, that any such storage media may contain computer-executable instructions for performing the methods described herein.

A number of program modules may be stored in the drives and RAM 512, comprising an operating system 530, one or more application programs 532, other program modules 534 and program data 536. All or portions of the operating system, applications, modules, and/or data may also be cached in the RAM 512. The systems and methods described herein may be implemented utilizing various commercially available operating systems or combinations of operating systems.

A user may enter commands and information into the computer 502 through one or more wired/wireless input devices, e.g., a keyboard 538 and a pointing device, such as a mouse 540. Other input devices (not shown) may comprise a microphone, an infrared (IR) remote control, a joystick, a game pad, a stylus pen, touch screen or the like. These and other input devices are often connected to the processing unit 504 through an input device interface 542 that may be coupled to the system bus 508, but may be connected by other interfaces, such as a parallel port, an IEEE 1394 serial port, a game port, a universal serial bus (USB) port, an IR interface, etc.

A monitor 544 or other type of display device may be also connected to the system bus 508 via an interface, such as a video adapter 546. It will also be appreciated that in alternative embodiments, a monitor 544 may also be any display device (e.g., another computer having a display, a smart phone, a tablet computer, etc.) for receiving display information associated with computer 502 via any communication means, including via the Internet and cloud-based networks. In addition to the monitor 544, a computer typically comprises other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 may be a workstation, a server computer, a router, a personal computer, portable computer, microprocessor-based entertainment appliance, a peer device or other common network node, and typically comprises many or all of the elements described relative to the computer 502, although, for purposes of brevity, only a remote memory/storage device 550 is illustrated. The logical connections depicted comprise wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which may connect to a global communications network, e.g., the Internet.

When used in a LAN networking environment, the computer 502 may be connected to the LAN 552 through a wired and/or wireless communication network interface or adapter 556. The adapter 556 may facilitate wired or wireless communication to the LAN 552, which may also comprise a wireless AP disposed thereon for communicating with the adapter 556.

When used in a WAN networking environment, the computer 502 may comprise a modem 558 or may be connected to a communications server on the WAN 554 or has other means for establishing communications over the WAN 554, such as by way of the Internet. The modem 558, which may be internal or external and a wired or wireless device, may be connected to the system bus 508 via the input device interface 542. In a networked environment, program modules depicted relative to the computer 502 or portions thereof, may be stored in the remote memory/storage device 550. It will be appreciated that the network connections shown are example and other means of establishing a communications link between the computers may be used.

The computer 502 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This may comprise Wireless Fidelity (Wi-Fi) and BLUETOOTH® wireless technologies. Thus, the communication may be a predefined structure as with a conventional network or simply an ad hoc communication between at least two devices.

Wi-Fi may allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network may be used to connect computers to each other, to the Internet, and to wired networks (which may use IEEE 802.3 or Ethernet). Wi-Fi networks operate in the unlicensed 2.4 and 5 GHz radio bands for example or with products that contain both bands (dual band), so the networks may provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art may recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which may comprise computer-readable storage media and/or communications media, which two terms are used herein differently from one another as follows. Computer-readable storage media may be any available storage media that may be accessed by the computer and comprises both volatile and nonvolatile media, removable and non-removable media. By way of example, and not limitation, computer-readable storage media may be implemented in connection with any method or technology for storage of information such as computer-readable instructions, program modules, structured data or unstructured data. Computer-readable storage media may comprise the widest variety of storage media including tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented may optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than may be recognized by the second item. In a further example of indirect coupling, an action in a first item may cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, may be used in the subject disclosure. For instance, one or more features from one or more embodiments may be combined with one or more features of one or more other embodiments. In one or more embodiments, features that are positively recited may also be negatively recited and excluded from the embodiment with or without replacement by another structural and/or functional feature. The steps or functions described with respect to the embodiments of the subject disclosure may be performed in any order. The steps or functions described with respect to the embodiments of the subject disclosure may be performed alone or in combination with other steps or functions of the subject disclosure, as well as from other embodiments or from other steps that have not been described in the subject disclosure. Further, more than or less than all of the features described with respect to an embodiment may also be utilized.

What is claimed is:

1. A method for managing financial services, the method comprising:
receiving, by a processing system including a processor, a voice command from a user representing a request for a financial service associated with a financial services platform, the processing system being part of a vehicle communication system of a vehicle;
providing, by the processing system via an Application Programming Interface (API), an authentication request to an authentication platform;
responsive to a successful authentication of the user by the authentication platform, determining, by the processing system, whether the financial service is authorized for the user during transit; and
in response to a determination that the financial service is not authorized for the user during transit, presenting, by the processing system, a notification to stop the vehicle to continue with the financial service.

2. The method of claim 1, wherein the determining whether the financial service is authorized for the user during transit is based on a first group of financial services that are pre-determined to not be authorized during transit, and wherein a second group of financial services are pre-determined to be authorized during transit.

3. The method of claim 2, wherein the notification is presented at a display of the vehicle communication system.

4. The method of claim 1, comprising capturing, by the processing system, an image of the user in the vehicle, wherein the providing of the authentication request to the authentication platform includes providing the image.

5. The method of claim 1, comprising:
capturing, by the processing system, an image of an interior of the vehicle that includes the user;
analyzing, by the processing system, the image to determine that a person other than the user is in the interior of the vehicle; and
determining, by the processing system, a privacy rule for the financial service based on the person being in the interior of the vehicle.

6. The method of claim 5, comprising:
determining, by the processing system, that the vehicle has stopped; and
continuing, by the processing system, with the financial service subject to the privacy rule.

7. The method of claim 1, comprising:
determining, by the processing system, that the vehicle has stopped; and
continuing, by the processing system, with the financial service by requiring the user to input information via a touch screen of the vehicle communication system.

8. The method of claim 1, comprising:
prior to the receiving of the voice command representing the request for the financial service, receiving, by the processing system, a registration request for the user associated with the financial services platform; and
providing, by the processing system via the API, a registration message to a registration platform associated with the financial services platform.

9. The method of claim 8, wherein the registration message causes a user profile associated with the user to be generated and stored at a database or to be accessed from the database.

10. The method of claim 8, wherein the registration message causes the registration platform to transmit a third-party request to a third-party database to obtain user data.

11. The method of claim 10, wherein the user data includes ownership information associated with the vehicle.

12. The method of claim 1, comprising:
capturing, by the processing system, an image of an interior of the vehicle that includes the user;
analyzing, by the processing system, the image to determine that a person other than the user is in the interior of the vehicle;
failing, by the processing system, to identify the person in the interior of the vehicle resulting in an identification failure; and
preventing the financial service from being completed based on the identification failure.

13. The method of claim 12, comprising transmitting an alert based on the preventing of the financial service from being completed.

14. A server, comprising:
a processing system including a processor; and
a memory that stores executable instructions that, when executed by the processing system, facilitate performance of operations, the operations comprising:
receiving, via an Application Programming Interface (API), a registration request for a user associated with a financial services platform that provides financial services via a vehicle communication system of a vehicle;
transmitting a third-party request to a third-party database to obtain user data associated with the user and with the vehicle; and
completing the registration based in part on the user data.

15. The server of claim 14, wherein the operations comprise generating a user profile associated with the user that is stored in a database.

16. The server of claim 14, wherein the operations comprise:
receiving, via the API, a first request for a first financial service; and
responsive to a successful authentication of the user by an authentication platform and responsive to a first authorization determination that the financial service is authorized for the user during transit, providing the first financial service via the vehicle communication system.

17. The server of claim 15, wherein the operations comprise:
receiving, via the API, a second request for a second financial service; and
responsive to a second authorization determination that the second financial service is not authorized for the user during transit and responsive to a determination that the vehicle has stopped, providing the second financial service via the vehicle communication system.

18. The server of claim 16, wherein the user data includes ownership information indicating that the user is the owner of the vehicle.

19. A non-transitory machine-readable medium, comprising executable instructions operating in association with a software development kit that, when executed by a processing system including a processor of a vehicle communication system of a vehicle, facilitate performance of operations, the operations comprising:
receiving a voice command from a user representing a request for a financial service associated with a financial services platform;
providing, via an Application Programming Interface (API), an authentication request to an authentication platform;
responsive to a successful authentication of the user by the authentication platform, determining whether the financial service is authorized for the user during transit; and
in response to a determination that the financial service is not authorized for the user during transit, presenting a notification to stop the vehicle to continue with the financial service.

20. The non-transitory machine-readable medium of claim 19, wherein the operations comprise capturing an image of the user in the vehicle, wherein the providing of the authentication request to the authentication platform includes providing the image.
